(19) United States
(12) Patent Application Publication
(10) Pub. No.: US 2008/0310247 A1
(43) Pub. Date: Dec. 18, 2008

(54) Concrete manufacturing facility and method of operation thereof

(76) Inventor: Richard Basaraba, Clarksburg, MD (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/811,829

(22) Filed: Jun. 12, 2007

(51) Int. Cl. B28C 7/04

(52) U.S. Cl. 366/8; 366/16

(57) ABSTRACT

A facility for manufacturing concrete and a method of operation thereof which allow for the benefits of alkali metal activated fly ash hydraulic cement to be realized, which allow the disadvantages associated therewith to be avoided, which allows widespread implementation of alkali metal activated fly ash hydraulic cement as a low-cost and environmentally-friendly substitute for Portland cement, in whole or in part, in traditional applications, and which enables new applications taking advantage of the superior characteristics of alkali metal activated fly ash cement.

### TECHNICAL FIELD

The present invention relates generally to building materials, and more specifically, to a concrete manufacturing facility and a method of operation thereof.

### BACKGROUND OF THE INVENTION

For centuries, cementitious compounds have been used to form solid structures, primarily in construction of buildings, temples, bridges, roads, dams, and the like. The ability of cementitious compounds to form building materials having high strength and durability has led to widespread use of such cementitious building materials, from structures formed on site, such as poured concrete slabs, pads, pillars, beams, walls, and the like, to pre-fabricated modular building materials such as concrete blocks, tiles, and modular wall sections.

Over time, numerous recipes or formulations for cementitious compounds have been developed. Portland cement is one cementitious compound that has numerous advantages for many applications. Specifically, Portland cement is a hydraulic cement that has an acceptable working time and cures quickly, to a high compressive strength. Portland cement is not, however, without its problems. Portland cement is difficult and costly to manufacture.

An alternative cement composition uses fly ash, a byproduct of combustion processes, such as those found in power generation. Fly ash alone is a suitable cementitious compound for certain applications, but is not a suitable substitute for Portland cement because it has substantially dissimilar characteristics, such as a much lower compressive strength. In order to produce a hydraulic cement with characteristics similar to Portland cement, alkali metal activators have been utilized, in small amounts, in combination with fly ash to form a much stronger hydraulic cement. When activated in this way, fly ash cements exhibit similar characteristics to a Portland cement, and offer certain other advantages over Portland cement. Specifically, fly ash is an inexpensive material compared to Portland cement, is readily available from local sources, and requires little or no processing. Furthermore, alkali metal activated fly ash hydraulic cement, when cured, can obtain compressive strengths higher than those easily obtainable with Portland cement.

Despite these advantages of alkali metal activated fly ash hydraulic cement, Portland cement has emerged as the most popular cement for nearly all modern applications. One reason for the widespread use of Portland cement is its ability to be stored in dry form, typically as a powder, and may effectively be stored with aggregate materials intermixed therewith. As a hydraulic cement, all that is required to use the powdered Portland cement, with or without aggregate materials, is the addition of an appropriate amount of water. Alkali metal activated fly ash cement, however, suffers from the disadvantage of degrading over time when stored as a hydraulic cement.

When alkali metal activated fly ash hydraulic cements are stored in a powdered form, moisture, such as humidity in the ambient air, causes hard prills or granules to form throughout the powder, such as around the alkali metal activator, thereby reducing or negating the beneficial effects of the alkali metal activator on the fly ash material. Specifically, the degradation of alkali metal activated fly ash hydraulic cement due to absorption of moisture causes the compressive strength of the cured cement to fall below acceptable levels, approaching those of fly ash alone, as well as causes other important characteristics to change, such as the working time. Thus, alkali metal activated fly ash hydraulic cements have been unsuccessful in the marketplace due to these shelf-life problems when utilized according to methods of use of Portland cement, as a substitute therefor.

For various applications, different methods of manufacturing concrete, and thus using the Portland cement contained therein, have been developed for various applications. One such method, typically used for mixing smaller batches of concrete, involves bagging pre-measured amounts of Portland cement and aggregate materials, such as sand and/or stones. The bags may then be stored, shipped, and sold, as necessary, as individual units. A consumer may purchase one of more of the bags, empty the contents thereof into a suitable mixing container, such as a bucket or a wheel barrow, add an appropriate amount of water to the Portland cement, mix to the appropriate consistency and/or homogeneity, and use the mixed concrete product as desired. Such bagged concrete products are well suited for forming small footers or other subterranean foundations, such as for supporting a porch, deck, pole, post, or the like, as well as for patching larger cement structures, such as a driveway, a wall, or the like, and for use in construction of larger structures as a bonding agent, such as a mortar application or the like.

An alternative method is typically used in ready-mix concrete plants and is more efficient for making larger batches of concrete for larger structures, such as sidewalks or driveways, larger foundations, for walls, or the like. The method involves adding pre-measured amounts of Portland cement, various aggregate materials, and water to a drum of a cement-mixing truck. The drum is rotated to mix the various components of the concrete batch, at least during transportation, and the truck is used to deliver the wet concrete from the ready-mix plant to a remote location for subsequent use during the working time of the cement.

Another similar alternative method, typically used for manufacturing pre-fabricated and/or modular building materials, such as traditional concrete blocks, aerated concrete blocks, or the like, or for forming prefabricated structure sections for subsequent assembly, is used in a facility similar to a ready-mix plant. The method involves adding pre-measured amounts of Portland cement, various aggregate materials, and water to a large mixer and mixing the material to the desired consistency and/or homogeneity. The mixed concrete is then molded into the finished products, i.e. blocks, pillars, beams, decorative elements, wall-sections, or the like. When the concrete is cured, the production is complete, and the finished products are ready for distribution and use.

These common methods of using concrete, and the Portland cement contained therein, illustrate why alkali metal activated fly ash hydraulic cements have not heretofore been widely adopted. Specifically, bagged cement products are typically manufactured in a first mixing and bagging facility, and stored there until shipped to a warehouse or other distribution facility. The bags of concrete are again stored until being shipped to a retail facility. Finally, the bags are stored at the retail facility until purchased. Thus, the time between the manufacture of the bagged concrete products and the time when they are purchased and/or used is typically at least a few weeks, and can be as long as a year or more. An alkali metal activated fly ash hydraulic cement based bagged concrete product will degrade more than an acceptable amount in a period of time as short as a few weeks or even a few days. Thus, alkali metal activated fly ash hydraulic cement is not suitable for use in conventional bagged concrete products manufactured and/or used according to conventional methods designed for Portland cement.

Similarly, concrete manufacture at traditional ready-mix plants, as well as at pre-fabricated concrete product manufacturing facilities, involves storage of the hydraulic cement used therein for long periods of time. Such storage poses no problems when using Portland cement, but alkali metal activated fly ash hydraulic cements will degrade, as discussed above, before they could typically be used. Thus, alkali metal activated fly ash hydraulic cements are unsuitable for use according to conventional methods as a substitute for Portland cement in traditional ready-mix plants, or the like, because of the degradation of the cement during storage.

Thus, what is needed is a facility for manufacturing concrete that is capable of utilizing alkali metal activated fly ash hydraulic cement, and a method of operation thereof, through which the benefits of alkali metal activated fly ash hydraulic cement may be realized, and through which the disadvantages associated therewith may be avoided. Such a facility and method of operation will allow widespread implementation of alkali metal activated fly ash hydraulic cement as a low-cost and environmentally-friendly substitute, in whole or in part, for Portland cement in traditional applications, and will enable new applications taking advantage of the superior characteristics of alkali metal activated fly ash cement.

### BRIEF SUMMARY OF THE INVENTION

Briefly described, in a preferred embodiment, the present invention overcomes the above-mentioned disadvantages and meets the recognized need for such a facility and method by providing storage means for storing fly ash separate from an alkali metal activator. The fly ash and alkali metal activator are preferably combined after separate storage and/or separate shipment thereof to form an alkali metal activated fly ash hydraulic cement. The storage means may preferably store pre-measured amounts of fly ash separate from pre-measured amounts of one or more alkali metal activators such that combination of the pre-measured amount of fly ash and the pre-measured amount of one or more alkali metal activators forms a hydraulic cement according to a predetermined formulation. One or more aggregate material and/or admixture material, preferably pre-measured, may also be stored, preferably in a pre-mixed concrete mixture with the pre-measured amount of fly ash.

A ready-mix concrete manufacturing facility preferably includes means for storing fly ash, means for storing an alkali metal activator separate from the fly ash, means for storing a hydraulic cement in dry form separate from the fly ash and separate from the alkali metal activator, means for storing at least one aggregate material, means for conveying a predetermined amount of the fly ash to a mixing means, means for conveying a predetermined amount of the alkali metal activator to the mixing means, means for conveying a predetermined amount of the hydraulic cement to the mixing means, means for conveying a predetermined amount of the at least one aggregate material to the mixing means, and means for conveying a predetermined amount of water to the mixing means.

A method of operating the ready-mix concrete facility preferably comprises the steps of storing fly ash in a means for storing fly ash, storing an alkali metal activator separate from the fly ash in a means for storing alkali metal activator separate from the fly ash, combining a predetermined amount of the fly ash, a predetermined amount of the alkali metal activator, and a predetermined amount of water, and mixing the predetermined amount of the fly ash, the predetermined amount of the alkali metal activator, and the predetermined amount of the water to form an alkali metal activated fly ash cement.

A pre-fabricated concrete product manufacturing facility preferably includes means for storing fly ash, means for storing an alkali metal activator separate from the fly ash, means for storing a hydraulic cement in dry form separate from the fly ash and separate from the alkali metal activator, means for storing at least one aggregate material, means for conveying a predetermined amount of the fly ash to a mixing means, means for conveying a predetermined amount of the alkali metal activator to the mixing means, means for conveying a predetermined amount of the hydraulic cement to the mixing means, means for conveying a predetermined amount of the at least one aggregate material to the mixing means, means for conveying a predetermined amount of water to the mixing means, and means for dispensing a concrete mixture mixed in the mixing means.

A method of operating the pre-fabricated concrete product manufacturing facility preferably comprises the steps of storing fly ash in a means for storing fly ash, storing an alkali metal activator separate from the fly ash in a means for storing alkali metal activator separate from the fly ash, combining a predetermined amount of the fly ash, a predetermined amount of the alkali metal activator, and a predetermined amount of water, mixing the predetermined amount of the fly ash, the predetermined amount of the alkali metal activator, and the predetermined amount of the water to form an alkali metal activated fly ash cement to form a concrete mixture, and dispensing the concrete mixture into a mold.

A bagging facility preferably includes means for storing fly ash, means for conveying the fly ash to a means for bagging the fly ash, means for storing a hydraulic cement in dry form separate from the fly ash, means for storing at least one aggregate material, means for conveying a predetermined amount of the fly ash to a mixing means, means for conveying a predetermined amount of the hydraulic cement to the mixing means, means for conveying a predetermined amount of the at least one aggregate material to the mixing means, means for dispensing a concrete mixture mixed in the mixing means to a means for bagging the concrete mixture.

An alkali metal activated fly ash cement product preferably comprises means for storing fly ash, means for storing an alkali metal activator, means for storing a hydraulic cement, and means for storing an aggregate material, wherein the means for storing the alkali metal activator prevents the alkali metal activator from contacting at least one of a humid gas, water, and the fly ash.

According to its major aspects and broadly stated, the present invention in its preferred form is a means for storing fly ash separate from one or more alkali metal activator to prevent degradation thereof and a method of use of an alkali metal activated fly ash hydraulic cement that prevents degradation thereof.

According to another aspect of the preferred embodiment, the storage means are incorporated in a ready-mix concrete manufacturing facility to allow the manufacture of an alkali metal activated fly ash hydraulic cement at the ready-mix concrete manufacturing facility; thereby, allowing substitution of some or all Portland cement with alkali metal activated fly ash hydraulic cement in ready-mix concrete applications.

According to another aspect of the preferred embodiment, the storage means are incorporated in a pre-fabricated concrete product manufacturing facility to allow the manufacture of an alkali metal activated fly ash hydraulic cement at the pre-fabricated concrete product manufacturing facility: thereby, allowing substitution of some or all Portland cement with alkali metal activated fly ash hydraulic cement in pre-fabricated concrete products.

According to another aspect of the preferred embodiment, the storage means are incorporated in a bagged concrete or bagged cement product to allow the manufacture of an alkali metal activated fly ash hydraulic cement at or near the location where the alkali metal activated fly ash cement is to be used; thereby, allowing substitution of some or all Portland cement in bagged cement or bagged concrete products.

According to another aspect of the preferred embodiment, the storage means stores the fly ash separate from the alkali metal activator until a time sufficiently close to the time when water is added to avoid substantial degradation of the alkali metal activated fly ash hydraulic cement.

According to another aspect of the preferred embodiment, the fly ash is mixed with the alkali metal activator to create an alkali metal activated fly ash hydraulic cement no more than approximately 24 hours before water is added to the alkali metal activated fly ash hydraulic cement; more preferably, the fly ash is mixed with the alkali metal activator no more than approximately 12 hours before water is added to the alkali metal activated fly ash hydraulic cement, and most preferably the fly ash is mixed with the alkali metal activator no more than approximately 1 hour before water is added to the alkali metal activated fly ash hydraulic cement, although water may be added as much as approximately 48 hours after the alkali metal activated fly ash hydraulic cement is created.

According to another aspect of the preferred embodiment, fly ash is mixed with the alkali metal activator no later than approximately 5 hours after water is added to the fly ash; more preferably, the fly ash is mixed with the alkali metal activator no later than approximately 2 hours after water is added to the fly ash, and, most preferably, the fly ash is mixed with the alkali metal activator no later than approximately 1 hour after water is added to the fly ash.

According to another aspect of the preferred embodiment, the ready-mix manufacturing facility may be integrated into a vehicle to enable manufacture of large batches of alkali metal activated fly ash hydraulic cement on site.

These and other features, and advantages of the present invention will become more apparent to those ordinarily skilled in the art after reading the following Detailed Description and Claims in light of the accompanying drawing Figures.

### BRIEF DESCRIPTION OF THE DRAWINGS

Accordingly, the present invention will be understood best through consideration of, and reference to, the following Figures, viewed in conjunction with the Detailed Description of the Preferred Embodiment referring thereto, in which like reference numbers throughout the various Figures designate like structure and in which:

FIG. 1 is a perspective view of a ready-mix concrete manufacturing facility according to the present invention;

FIG. 2 is a flow chart illustrating a method of operation of the ready-mix concrete manufacturing facility of FIG. 1;

FIG. 3 is a perspective view of a pre-fabricated concrete product manufacturing facility according to the present invention;

FIG. 4 is a flow chart illustrating a method of operation of the pre-fabricated concrete product manufacturing facility of FIG. 3;

FIG. 5 is a perspective view of a bagging facility according to the present invention;

FIG. 6 is a perspective view of a bag according to the present invention; and

FIG. 7 is a flow chart illustrating a method of operation of the cement bagging facility of FIG. 5.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

In describing preferred embodiments of the present invention illustrated in the Figures, specific terminology is employed for the sake of clarity. The invention, however, is not intended to be limited to the specific terminology so selected, and it is to be understood that each specific element includes all technical equivalents that operate in a similar manner to accomplish a similar purpose.

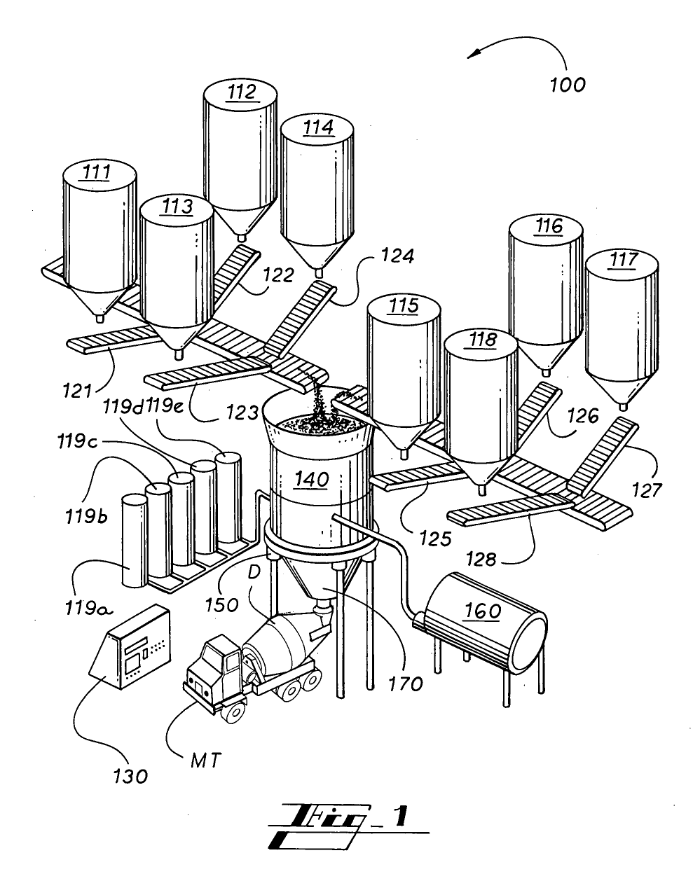

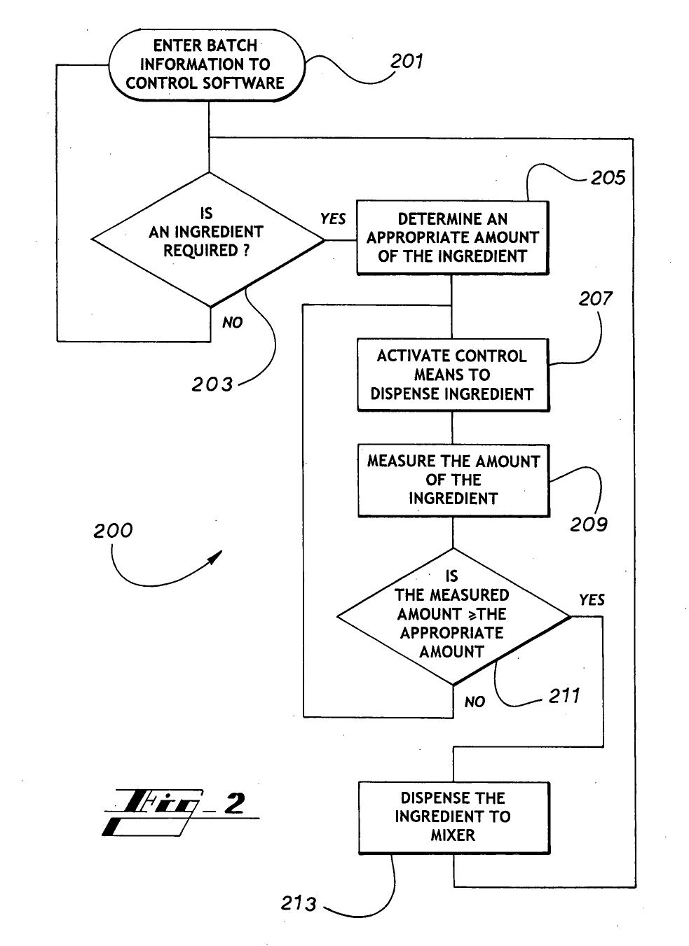

In that form of the preferred embodiment of the present invention chosen for purposes of illustration, FIGS. 1-2 show ready-mix concrete manufacturing facility 100, including storage means 111-119, conveyor means 121-129, control means 130, mixing means 140, scale 150, and water supply 160. Storage means 111, such as in the form of a silo, preferably stores fly ash, such as class C fly ash, class F fly ash, or a combination thereof, and is preferably selectively operable to dispense the fly ash to conveyor means 121 associated therewith, such as a conveyor belt, an auger, a hose, a pipe, or the like, according to control signals from control means 130. Conveyor means 121 preferably selectively conveys fly ash from storage means 111 to mixing means 140 according to control signals from control means 130. Scale 150 is preferably operably associated with mixing means 140 so that a weight of the contents of mixing means 140 can be determined. Scale 150 is preferably further operably associated with control means 130 such that an indication of the weight can be sent to control means 130 for use in selectively controlling the dispensing of the fly ash from storage means 111; thereby, allowing the desired amount of fly ash to be added to mixing means 140. Scale 150 preferably likewise indicates amounts of each additional ingredient of a batch added to mixing means 140 such that control means 130 may selectively control the dispensing of such additional ingredients; thereby, allowing the proper formulation of concrete to be attained.

Storage means 112 preferably stores a first alkali metal activator, such as potassium carbonate, and is preferably selectively operable, according to control signals from control means 130 based on indications from scale 350, to selectively dispense the first alkali metal activator to conveyor means 122, operably associated therewith. Conveyor means 122 preferably selectively conveys the first alkali metal activator to mixing means 140 according to control signals from control means 130 based on indications from scale 150. Storage means 113 preferably stores a second alkali metal activator, such as lithium carbonate, and is preferably selectively operable, according to control signals from control means 130, to dispense the second alkali metal activator to conveyor means 123, operably associated therewith. Conveyor means 123 preferably selectively conveys the second alkali metal activator to mixing means 140 according to control signals from control means 130 based on indications from scale 150. Storage means 114 preferably stores citric acid, and is preferably selectively operable, according to control signals from control means 130, based on indications from scale 150, to selectively dispense the citric acid to conveyor means 124, operably associated therewith. Conveyor means 124 preferably selectively conveys the citric acid to mixing means 140 according to control signals from control means 130 based on indications from scale 150.

Storage means 115-118 preferably store a hydraulic cement, such as Portland cement, a first aggregate material, such as sand, a second aggregate material, such as gravel, and a third aggregate material, such as stones, respectively. Each of storage means 115-118 is preferably operably connected to conveyor means 125-128, respectively, and is preferably selectively operable for dispensing the respective contents thereof to the respective conveyor means 125-128 associated therewith according to control signals from control means 130 based on indications from scale 150. Each of storage means 119a-119e preferably stores a respective admixture material, such as a plasticizer, a retarder, an accelerator, a water-reducer, a foaming or air-entraining agent, a tint or dye, boric acid, slag, silica, borax, gypsum, sawdust, straw, woodchips, structural fibers, or the like, for selective addition to mixing means 140 according to control signals from control means 130.

Thus, control means 130 may preferably control each of storage means 111-119 and conveyor means 121-129 to deliver predetermined amounts of the contents of storage means 111-119 to mixing means 140 to create a batch of material, such as concrete, mortar, or the like, of a desired size, having a desired formulation. Preferably, mixing means 140 substantially homogenizes the dry ingredients of the concrete formulation, and dispenses such substantially homogenous mixture to drum D of mixing truck MT via dispensing means 170. A predetermined amount of water, based on the selected concrete formulation, is preferably added to drum D via water supply 160.

As will be understood by those skilled in the art, storage means 111-119 and conveyor means 121-129 may be formed from any suitable materials, and may be arranged according to numerous various possible arrangements as needed or desired for any particular implementation or site. Furthermore, storage means 111-119 may include additional components as needed or desired, such as vibrators, grinders, aerators, fluidizers, pumps, sprayers, valves, sensors, monitors, scales, metering means, or other like. Additionally, conveyor means 121-129 may include additional components as needed or desired, such as covers, valves, sensors, monitors, metering means, or the like. In particular, such additional components may enhance or substitute for the function of one or more elements of ready-mix manufacturing plant 100. For example, scale 150 may be replaced with alternative or additional scales, flow meters, or other metering means operably associated with each of storage means 111-119 or conveyor means 121-129 and capable of outputting indications corresponding to an amount of material dispensed to an associated conveyor means or mixing means such that control means 130 is capable of controlling an amount of the respective contents of each storage means added to a particular batch of material. Finally, one or more additional or further storage means may be included, with associated conveyor means, in order to allow additional ingredients to be included in a particular batch of material. Similarly, mixing means 140 may be eliminated and the ingredients of the batch of material may be mixed entirely by drum D of mixing truck MT. Likewise, one or more of conveyor means 121-129 may be replaced, eliminated, or modified to convey ingredients from a plurality, or even all, of storage means 111-119.

In use, ready-mix manufacturing facility 100 is preferably operated according to method 200. Method 200 preferably begins with step 201, where batch information, including predetermined information regarding batch size and a specific batch formulation, is preferably entered into control software of control means 130. The control software preferably determines, at step 203, whether an ingredient is required according to the batch information. For the necessary ingredient, the control software preferably determines an appropriate amount of the necessary ingredient to be dispensed at step 205. The control software, at step 207, preferably activates control means 130 to send appropriate control signals to a corresponding one of storage means 111-119 containing the necessary ingredient and to a corresponding one of conveyor means 121-129 associated therewith, or to water supply 160, to automatically dispense an amount of the necessary ingredient substantially equal to the appropriate amount (determined in step 205) and to convey the ingredient to mixing means 140 or drum D of mixing truck MT to produce a batch of material according to the batch information. At step 209, the amount of the necessary ingredient is measured. At step 211, the measured amount is compared to the appropriate amount. If the measured amount is less than the appropriate amount, the method returns to step 207. If the measure amount is greater than or equal to the appropriate amount, the software preferably sends a control signal to dispense the measured amount of the ingredient to a mixer, such as mixing means 140 or drum D of mixing truck MT, at step 213. The method then returns to step 203 and repeats steps 205-213 until it is determined at step 203 that no ingredient is required according to the batch information. The process then returns to step 201 and awaits the input of new batch information for a new batch. Thus, ready-mix concrete manufacturing facility 100, and method 200 of operation thereof, allows for the manufacture of a batch of material, such as concrete, mortar, or the like, according to virtually any formulation, including those calling for alkali metal activated fly ash cement.

As will be understood by one ordinarily skilled in the art, additional or alternative steps may be included in method 200 without departing from the scope of the invention, so long as fly ash, one or more alkali metal activator, and any other necessary or desired ingredients may be stored such that degradation thereof is prevented. For example, method 200 may include the steps of providing batch information including instructions regarding the formulation of a batch of concrete, cement, mortar, or the like, or information including required or desired performance characteristics of a formulated concrete, cement, mortar, or the like; determining an amount of Portland, or other, hydraulic cement to be substituted with alkali metal activated fly ash cement; and determining an amount of alkali metal activated fly ash cement to be used as a substitute for the Portland, or other, hydraulic cement that will yield a product having substantially similar performance characteristics as a product formulated according to the batch information without any substitutions. Likewise, alternative methods of selecting and metering desired ingredients may be used to combine fly ash, one or more alkali metal activator, and any other necessary or desired ingredient for use as a hydraulic cement at ready-mix concrete manufacturing facility 100, especially as a substitute, in whole or in part, for Portland cement.

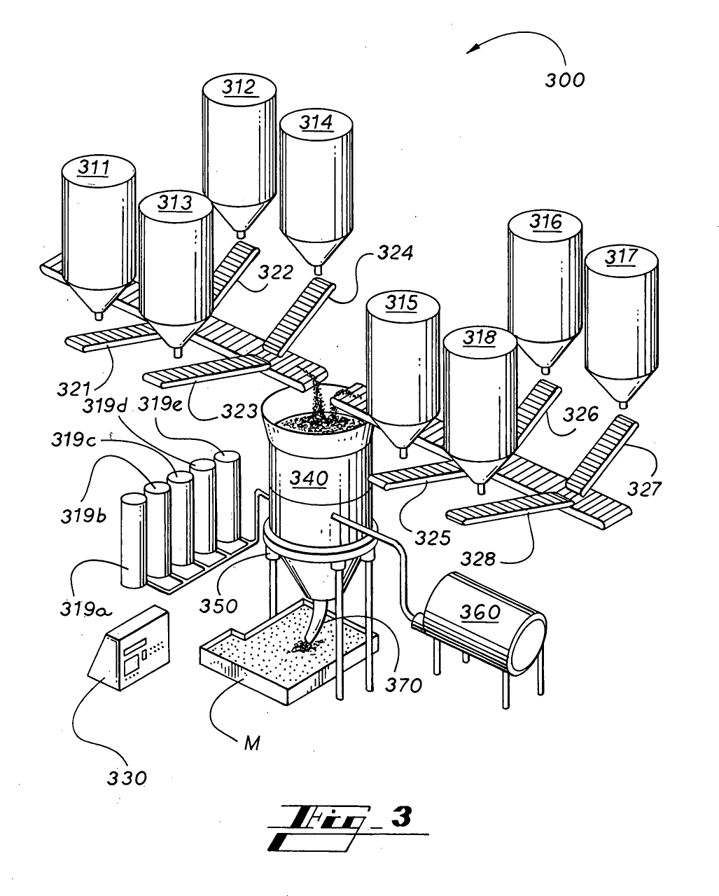

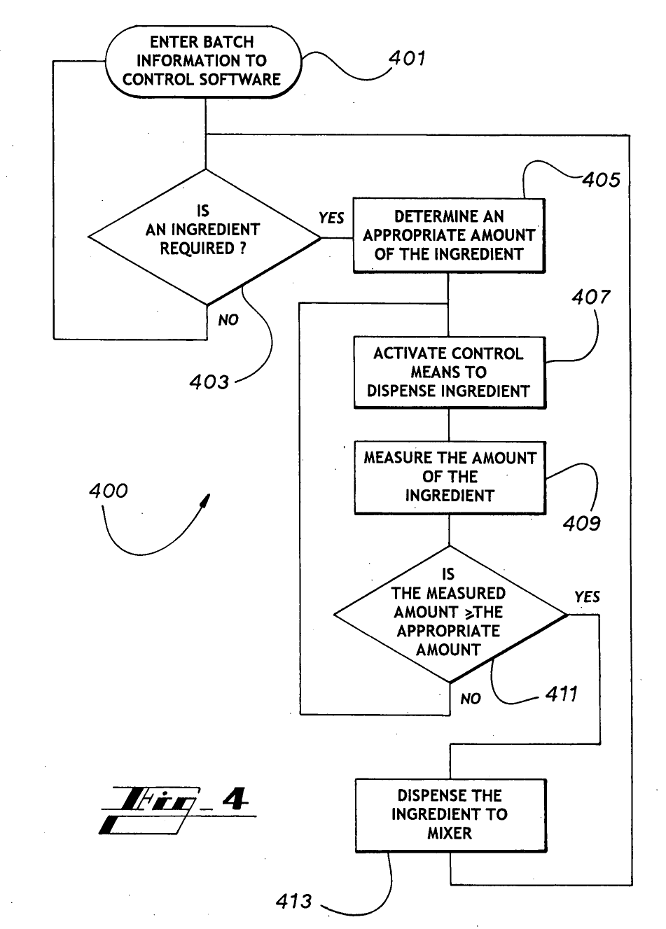

Now referring to FIGS. 3-4, pre-fabricated concrete product manufacturing facility 300 preferably includes storage means 311-319, conveyors 321-329, control means 330, mixing means 340, scale 350, water supply 360, and dispensing means 370. Storage means 311, such as in the form of a silo, preferably stores fly ash, and is preferably selectively operable to dispense the fly ash to conveyor means 321 associated therewith, such as a conveyor belt, an auger, a hose, a pipe, or the like, according to control signals from control means 330. Conveyor means 321 preferably selectively conveys fly ash from storage means 311 to mixing means 340 according to control signals from control means 330. Scale 350 is preferably operably associated with mixing means 340 so that a weight of the contents of mixing means 340 can be determined. Scale 350 is preferably further operably associated with control means 330 such that an indication of the weight can be sent to control means 330 for use in selectively controlling the dispensing of the fly ash from storage means 311, thereby allowing the desired amount of fly ash to be added to mixing means 340. Scale 350 preferably likewise indicates amounts of each additional ingredient of a batch added to mixing means 340 such that control means 330 may selectively control the dispensing of such additional ingredients, thereby allowing the proper formulation of concrete to be attained.

Storage means 312 preferably stores a first alkali metal activator, such as potassium carbonate, and is preferably selectively operable, according to control signals from control means 330 based on indications from scale 350, to selectively dispense the first alkali metal activator to conveyor means 322, operably associated therewith. Conveyor means 322 preferably selectively conveys the first alkali metal activator to mixing means 340 according to control signals from control means 330 based on indications from scale 350. Storage means 313 preferably stores a second alkali metal activator, such as lithium carbonate, and is preferably selectively operable, according to control signals from control means 330 based on indications from scale 350, to dispense the second alkali metal activator to conveyor means 323, operably associated therewith. Conveyor means 323 preferably selectively conveys the second alkali metal activator to mixing means 340 according to control signals from control means 330 based on indications from scale 350. Storage means 314 preferably stores citric acid, and is preferably selectively operable, according to control signals from control means 330, based on indications from scale 350, to selectively dispense the citric acid to conveyor means 324, operably associated therewith. Conveyor means 324 preferably selectively conveys the citric acid to mixing means 340 according to control signals from control means 330 based on indications from scale 350.

Storage means 315-318 preferably store a hydraulic cement, such as Portland cement, a first aggregate material, such as sand, a second aggregate material, such as gravel, and a third aggregate material, such as stones, respectively. Each of storage means 315-318 is preferably operably connected to conveyor means 325-328, respectively, and is preferably selectively operable for dispensing the respective contents thereof to the respective conveyor means 325-328 associated therewith according to control signals from control means 330 based on indications from scale 350. Each of storage means 319a-319e preferably stores a respective admixture material, such as a plasticizer, a retarder, an accelerator, a water-reducer, a foaming or air-entraining agent, a tint or dye, boric acid, slag, silica, borax, gypsum, sawdust, straw, woodchips, structural fibers, or the like, for selective addition to mixing means 340 according to control signals from control means 330. A predetermined amount of water, based on the selected concrete formulation, is preferably added to mixing means 340 via water supply 360 and is preferably mixed to create a concrete mixture with the desired consistency and homogeneity.

Thus, control means 330 may preferably control each of storage means 311-319 and conveyor means 321-329 to deliver predetermined amounts of the contents of storage means 311-319 to mixing means 340 to create a desired amount of a concrete material having a desired formulation. Preferably, mixing means 340 substantially homogenizes the dry ingredients of the concrete formulation, the water, and any liquid ingredients (typically the admixtures may be liquid, although other ingredients, such as one or more alkali metal activator and/or the citric acid may be liquid), and dispenses such substantially homogenous mixture to mold M, or other container, for use in manufacturing a pre-fabricated concrete structure or building material via dispensing means 370.

As will be understood by those skilled in the art, storage means 311-319 and conveyor means 321-329 may be formed from any suitable materials, and may be arranged according to numerous various possible arrangements as needed or desired for any particular implementation or site. Furthermore, storage means 311-319 may include additional components as needed or desired, such as vibrators, grinders, aerators, fluidizers, pumps, sprayers, valves, sensors, monitors, scales, metering means, or other like. Additionally, conveyor means 321-329 may include additional components as needed or desired, such as covers, valves, sensors, monitors, metering means, or the like. In particular, such additional components may enhance or substitute for the function of one or more elements of pre-fabricated concrete product manufacturing facility 300. For example, scale 350 may be replaced with alternative or additional scales, flow meters, or other metering means operably associated with each of storage means 311-319 and conveyor means 321-329 and capable of outputting indications of an amount of material dispensed to an associated conveyor means or mixing means such that control means 330 is capable of controlling an amount of the respective contents of each of storage means 311-319 added to a particular batch of concrete. Finally, one or more additional or further storage means may be included, with associated conveyor means, in order to allow additional ingredients to be included in a particular batch of concrete. Similarly, one or more of conveyor means 321-329 may be replaced, eliminated, or modified to convey ingredients from a plurality, or even all, of storage means 311-319.

In use, pre-fabricated concrete product manufacturing facility 300 is preferably operated according to method 400. Method 400 preferably begins with step 401, where batch information, including predetermined information regarding batch size and a specific formulation of the concrete batch, is preferably entered into control software of control means 330. The control software preferably determines, at step 403, whether an ingredient is required according to the batch information. For the necessary ingredient, the control software preferably determines an appropriate amount of the necessary ingredient to be dispensed at step 405. The control software, at step 407, preferably activates control means 330 to send appropriate control signals to a corresponding one of storage means 311-319 containing the necessary ingredient and to a corresponding one of conveyor means 321-329 associated therewith, or to water supply 360, to automatically dispense an amount of the necessary ingredient substantially equal to the appropriate amount (determined in step 405) and to convey the ingredient to mixing means 340 to produce a batch of concrete according to the batch information. At step 409, the amount of the necessary ingredient is measured. At step 411, the measured amount is compared to the appropriate amount. If the measured amount is less than the appropriate amount, the method returns to step 407. If the measure amount is greater than or equal to the appropriate amount, the software preferably sends a control signal to dispense the measured amount of the ingredient to a mixer, such as mixing means 340, at step 413. The method then returns to step 403 and repeats steps 405-413 until it is determined at step 403 that no ingredient is required according to the batch information. The process then returns to step 401 and awaits the input of new batch information for a new batch. Thus, pre-fabricated concrete product manufacturing facility 300, and method 400 of operation thereof, allows for the manufacture of a batch of concrete according to virtually any formulation, including those calling for alkali metal activated fly ash cement.

As will be understood by one ordinarily skilled in the art, additional or alternative steps may be included in method 400 without departing from the scope of the invention, so long as fly ash, one or more alkali metal activator, and any other necessary or desired ingredients may be stored such that degradation thereof is prevented. Likewise, alternative methods of selecting and metering desired ingredients may be used to combine fly ash, one or more alkali metal activator, and any other necessary or desired ingredient for use as a hydraulic cement at pre-fabricated concrete product manufacturing facility 300, especially as a substitute, in whole or in part, for Portland cement.

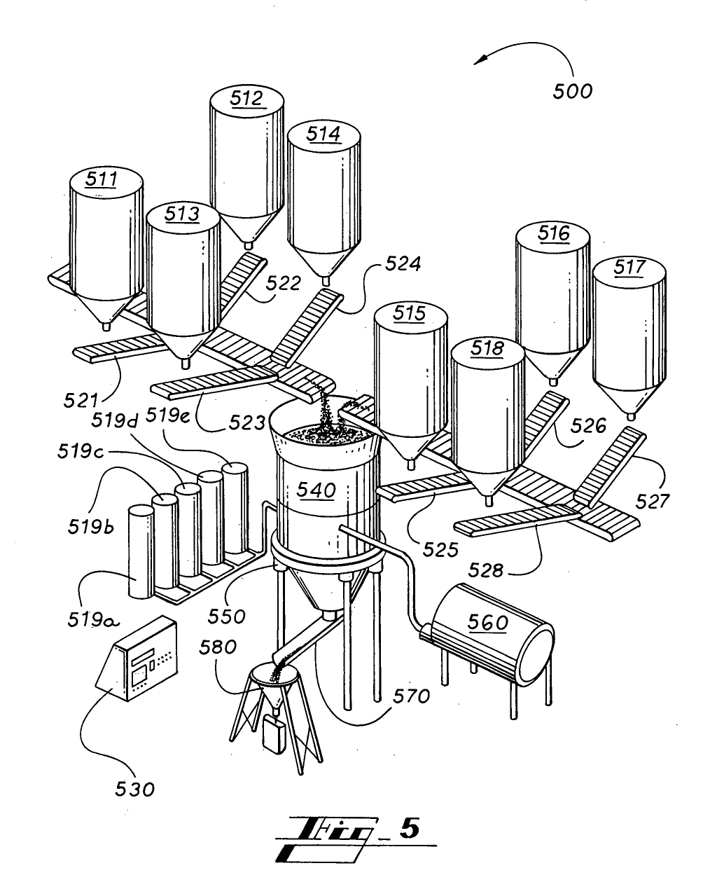

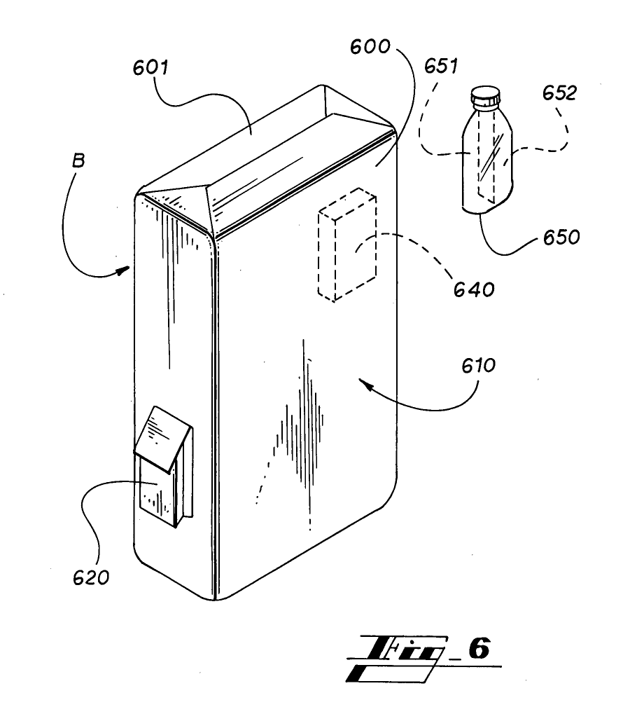

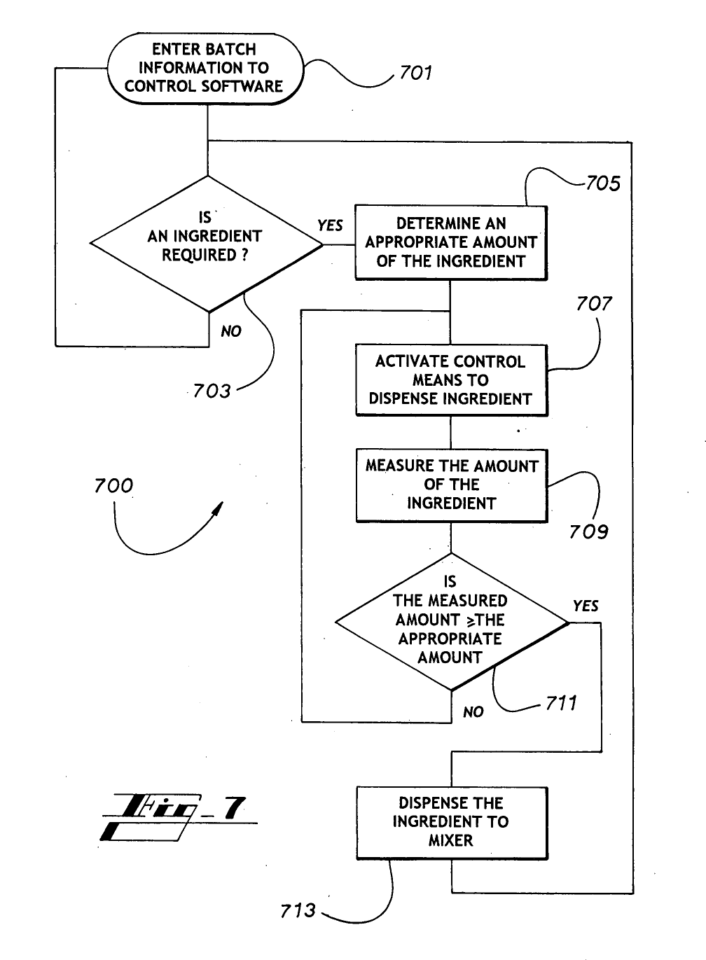

Now referring to FIGS. 5-7, bagging facility 500 preferably includes storage means 511-517, conveyors 521-527, control means 530, mixing means 540, scale 550, dispensing means 570, and bagging means 580. Storage means 511 such as in the form of a silo, preferably stores fly ash, and is preferably selectively operable to dispense the fly ash to conveyor means 521 associated therewith, such as a conveyor belt, an auger, a hose, a pipe, or the like, according to control signals from control means 530. Conveyor means 521 preferably selectively conveys fly ash from storage means 511 to mixing means 540 according to control signals from control means 530. Scale 550 is preferably operably associated with mixing means 540 so that a weight of the contents of mixing means 540 can be determined. Scale 550 is preferably further operably associated with control means 530 such that an indication of the weight can be sent to control means 530 for use in selectively controlling the dispensing of the fly ash from storage means 511, thereby allowing the desired amount of fly ash to be added to mixing means 540. Scale 550 preferably likewise indicates amounts of each additional ingredient of a batch of material added to mixing means 540 such that control means 530 may selectively control the dispensing of such additional ingredients, thereby allowing the proper formulation of material to be attained.

Storage means 512 preferably stores citric acid, and is preferably selectively operable, according to control signals from control means 530, based on indications from scale 550, to selectively dispense the citric acid to conveyor means 522, operably associated therewith. Conveyor means 522 preferably selectively conveys the citric acid to mixing means 540 according to control signals from control means 530 based on indications from scale 550.

Storage means 513-516 preferably store a hydraulic cement, such as Portland cement, a first aggregate material, such as sand, a second aggregate material, such as gravel, and a third aggregate material, such as stones, respectively. Each of storage means 513-516 is preferably operably connected to conveyor means 523-526, respectively, and is preferably selectively operable for dispensing the respective contents thereof to the respective conveyor means 523-526 associated therewith according to control signals from control means 530 based on indications from scale 550. Each of storage means 517a-517e preferably stores a respective admixture material, such as a plasticizer, a retarder, an accelerator, a water-reducer, a foaming or air-entraining agent, a tint or dye, boric acid, slag, silica, borax, gypsum, sawdust, straw, woodchips, structural fibers, or the like, for selective addition to mixing means 540 according to control signals from control means 530.

Thus, control means 530 may preferably control each of storage means 511-517 and conveyor means 511-517 to deliver predetermined amounts of the contents of storage means 511-517 to mixing means 540 to create a desired amount of a material mixture having a desired formulation. Preferably, mixing means 540 substantially homogenizes the fly ash, citric acid, one or more aggregate materials, and any other ingredients, and dispenses such substantially homogenous material mixture to bagging means 580 via dispensing means 570. Bagging means 580 preferably produces bagged cement product B comprising bag 600 and concrete mixture contained therein. Bag 600 is preferably sealed, such as at top edge 601, and preferably contains a pre-determined amount, typically by weight, of the concrete mixture. Since bag 600 does not contain any alkali metal activator, bag. 600 prevents degradation of the concrete mixture, and allows bagged cement product B to be stored and/or shipped as needed.

Sealed container 650 containing one or more alkali metal activator, either in liquid or powder form, is preferably included with bag 600, sealed thereinside during the bagging process, such as in interior compartment 640. Sealed container 650 may alternatively be attached to exterior 610 of bag 600, such as in external compartment 620, or included at the point of retail sale of bagged cement product B. Sealed container 650 preferably includes a predetermined amount of alkali metal activator appropriate to activate the quantity of fly ash contained in bag 600. Thus, different sealed containers 650 may contain different amounts and/or formulations of alkali metal activator appropriate for different concrete formulations. Sealed container 650 may additionally contain one or more liquid or powder admixtures, if it is desirable to maintain such admixtures separate from the contents of bag 600. Furthermore, sealed container 650 may include separate compartments 651 and 652 therewithin for maintaining the alkali metal activator separate from any admixtures, if such separation is necessary to prevent degradation of either.

As will be understood by those skilled in the art, storage means 511-517 and conveyor means 521-527 may be formed from any suitable materials, and may be arranged according to numerous various possible arrangements as needed or desired for any particular implementation or site. Furthermore, storage means 511-517 may include additional components as needed or desired, such as vibrators, grinders, aerators, fluidizers, pumps, sprayers, valves, sensors, monitors, scales, metering means, or other like. Additionally, conveyor means 521-527 may include additional components as needed or desired, such as covers, valves, sensors, monitors, metering means, or the like. In particular, such additional components may enhance or substitute for the function of one or more elements of bagging facility 500. For example, scale 550 may be replaced with alternative or additional scales, flow meters, or other metering means operably associated with each of storage means 511-517 and capable of outputting indications corresponding to an amount of material dispensed to an associated conveyor means or mixing means such that control means 530 is capable of controlling an amount of the respective contents of each of storage means 511-517 added to a particular batch of material. Finally, one or more additional or further storage means may be included, with associated conveyor means, in order to allow additional ingredients to be included in a particular batch of material. Similarly, one or more of conveyor means 521-527 may be replaced, eliminated, or modified to convey ingredients from a plurality, or even all, of storage means 511-517.

In use, bagging facility 500 is preferably operated according to method 700. Method 700 preferably begins with step 701, where batch information, including predetermined regarding batch size and formulation, is preferably entered into control software of control means 530. The control software preferably determines, at step 703, whether an ingredient is required according to the batch information. For the necessary ingredient, the control software preferably determines an appropriate amount of the necessary ingredient to be dispensed at step 705. The control software, at step 707, preferably activates control means 530 to send appropriate control signals to a corresponding one of storage means 511-517 containing the necessary ingredient and to a corresponding one of conveyor means 521-527 associated therewith to automatically dispense an amount of the necessary ingredient substantially equal to the appropriate amount (determined in step 705) and convey the ingredient to mixing means 540 to produce a batch of material according to the batch information. At step 709, the amount of the necessary ingredient is measured. At step 711, the measured amount is compared to the appropriate amount. If the measured amount is less than the appropriate amount, the method returns to step 707. If the measure amount is greater than or equal to the appropriate amount, the software preferably sends a control signal to dispense the measured amount of the ingredient to a mixer, such as mixing means 540, at step 713. The method then returns to step 703 and repeats steps 705-713 until it is determined at step 703 that no ingredient is required according to the batch information. The process then returns to step 701 and awaits the input of new batch information for a new batch. Thus, bagging facility 500, bag 600, and method 700 of operation thereof, allows for the manufacture of a pre-mixed and pre-measured cement product according to virtually any formulation, including those calling for alkali metal activated fly ash cement.

As will be understood by one ordinarily skilled in the art, additional or alternative steps may be included in method 700 without departing from the scope of the invention, so long as fly ash, one or more alkali metal activator, and any other necessary or desired ingredients may be stored such that degradation thereof is prevented. Likewise, alternative methods of selecting and metering desired ingredients may be used to combine fly ash and any other necessary or desired ingredient and a separately stored alkali metal activator for subsequent storage and/or shipment thereof as a substitute, in whole or in part, for bagged Portland cement products by combining the separate alkali metal activator and the bagged material mixture to form a hydraulic cement and adding an appropriate amount of water thereto.

While nearly any formulation of cement, concrete, mortar, or the like may be manufactured according to the present invention, the preferred formulation comprises fly ash and an alkali metal activator. Additionally, the formulation may further comprise one or more additional hydraulic cement, such as Portland cement, one or more aggregate material, and/or one or more admixture material. The formulation may be selected to include, by weight, 15% to 89.9% Class C fly ash, 0.1% to 4.2% Potassium Carbonate, 0% to 5% Citric Acid, and 10% to 84.9% type I Portland cement. An alternative formulation may be selected to include, by weight, 35% to 89.9% Class C fly ash, 0.1% to 4.2% Potassium Carbonate, 0% to 3% Lithium Carbonate, 0% to 5% Citric Acid, and 10% to 64.4% type I Portland cement. Exemplary formulations include the following formulations.

### EXAMPLE 1

### EXAMPLE 2

### EXAMPLE 3

### EXAMPLE 4

Although the storage means of the present invention have been illustrated, for exemplary purposes, in the form of one or more silos, it will be understood that such storage means may take other forms, such as bins, boxes, bottles, tanks, bags, hoppers, piles, trucks, containers, combinations thereof, or the like, without departing from the scope of the present invention. Similarly, the conveyor means of the present invention may take the form of belts, tubes, pipes, shafts, augers, pumps, blowers, gears, scoops, sprayers, shovels, combinations thereof, or the like, without departing from the scope of the present invention. Likewise, the mixing means of the present invention may take the form of vibrators, agitators, augers, gears, paddles, tumblers, drums, sifters, grinders, blenders, buckets, wheel barrows, combinations thereof, or the like, without departing from the scope of the present invention.

Having, thus, described exemplary embodiments of the present invention, it should be noted by those skilled in the art that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

What is claimed is at least:

1. A ready-mix concrete manufacturing facility comprising:
means for storing fly ash;
means for storing an alkali metal activator separate from a fly ash;
means for storing a hydraulic cement in dry form separate from said fly ash and separate from an alkali metal activator;
means for storing at least one aggregate material;
means for conveying a predetermined amount of said fly ash from said means for storing fly ash to a mixing means;
means for conveying a predetermined amount of said alkali metal activator from said means for storing an alkali metal activator to said mixing means;
means for conveying a predetermined amount of a hydraulic cement from said means for storing a hydraulic cement to said mixing means;
means for conveying a predetermined amount of at least one aggregate material from said means for storing at least one aggregate material to said mixing means; and
means for conveying a predetermined amount of water to said mixing means.

2. The ready-mix concrete manufacturing facility of claim 1, wherein said means for mixing comprises a mixing truck.

3. The ready-mix concrete manufacturing facility of claim 1, wherein said means for storing said alkali metal activator prevents said alkali metal activator from exposure to one of water and a humid gas while said alkali metal activator is stored within said means for storing said alkali metal activator.

4. The ready-mix concrete manufacturing facility of claim 1, further comprising means for storing a cement admixture material and means for conveying a predetermined amount of said cement admixture material to said mixing means.

5. The ready-mix concrete manufacturing facility of claim 4, wherein said cement admixture material is selected from the group consisting of citric acid, lithium carbonate, a water-reducing admixture, a plasticizing admixture, an air-entraining admixture, a retarding admixture, and an accelerating admixture.

6. The ready-mix concrete manufacturing facility of claim 1, wherein said means for storing an alkali metal activator separate from comprises means for storing a plurality of different alkali metal activators separate from said fly ash material.

7. A method of operating a ready-mix concrete facility comprising the steps of:
storing fly ash in a means for storing fly ash;
storing an alkali metal activator separate from said fly ash in a means for storing an alkali metal activator separate from a fly ash;
combining a predetermined amount of said fly ash, a predetermined amount of an alkali metal activator, and a predetermined amount of water; and
mixing said predetermined amount of said fly ash, said predetermined amount of said alkali metal activator, and said predetermined amount of said water to form an activated fly ash cement.

8. The method of claim 7, wherein the step of combining further comprises combining a predetermined amount of a hydraulic cement.

9. The method of claim 7, wherein the step of combining further comprises combining a predetermined amount of at least one aggregate material.

10. The method of claim 7, wherein the step of combining further comprises combining a predetermined amount of a hydraulic cement admixture selected from the group consisting of citric acid, a water-reducing admixture, a plasticizing admixture, an accelerating admixture, a retarding admixture, and an air-entraining admixture.

11. The method of claim 7, wherein the step of mixing is performed in a drum of a mixing truck.

12. The method of claim 7, wherein the step of combining is performed by adding each of said predetermined amount of fly ash, said predetermined amount of alkali metal activator, and said predetermined amount of said water to a drum of a mixing truck.

13. The method of claim 7, wherein said means for storing said alkali metal activator prevents said alkali metal activator stored therein from exposure to one of water and a humid gas.

14. The method of claim 7, further comprising the steps of:
conveying a predetermined amount of said fly ash from said means for storing said fly ash to a means for mixing; and
conveying a predetermined amount of said alkali metal activator from said means for storing said alkali metal activator to said means for mixing.

15. The method of claim 7, further comprising the steps of:
providing information for formulating a batch of concrete including Portland cement;
determining an amount of the Portland cement to be substituted with alkali metal activated fly ash cement; and
determining an amount of activated fly ash cement to use to substitute for the Portland cement such that said activated fly ash cement formed by said mixing step comprises at least one performance characteristic that is at least one of substantially similar to and superior to a corresponding characteristic of a batch of concrete formulated according to the information,
whereby said step of determining provides said predetermined amount of said fly ash and said predetermined amount of an alkali metal activator.

16. The method of claim 15, wherein said step of determining further provides said predetermined amount of water.

17. The method of claim 7, wherein said combining step is completed in an amount of time less than approximately forty-eight hours from a time when said combining step is begun.

18. The method of claim 7, wherein said combining step is completed in an amount of time less than approximately twenty-four hours from a time when said combining step is begun.

19. The method of claim 7, wherein said combining step is completed in an amount of time less than approximately twelve hours from a time when said combining step is begun.

20. The method of claim 7, wherein said combining step is completed in an amount of time less than approximately one hour from a time when said combining step is begun.
